(19) United States
(12) Patent Application Publication
(10) Pub. No.: US 2016/0290378 A1
(43) Pub. Date: Oct. 6, 2016

(54) STACKABLE ARTICLE OF FURNITURE

(71) Applicant: Sauder Manufacturing Co., Archbold, OH (US)

(72) Inventors: W. Ronald Russ, Richmond, VA (US); Lawrence Giaimo, Moseley, VA (US)

(73) Assignee: Sauder Manufacturing Co., Archbold, OH (US)

(21) Appl. No.: 14/676,942

(22) Filed: Apr. 2, 2015

(51) Int. Cl. F16B 12/10; A47B 47/00; A47C 19/02

(52) U.S. Cl. CPC F16B 12/10; A47C 19/028; A47C 19/02; A47B 47/0091

(57) ABSTRACT

A stackable article of furniture comprises at least one post having a longitudinal axis, a first end and a second end. A channel is formed in the at least one post parallel to the longitudinal axis and a pin is pivotally mounted to the at least one post within the channel and pivotable between a first position and a second position.

### BACKGROUND

Stackable articles of furniture such as bunk beds, loft beds, shelving or the like typically include a fastening device to secure the stackable articles of furniture together. When unstacked, these fasteners typically protrude from the article of furniture or must be removed from the article of furniture.

### BRIEF SUMMARY

According to an embodiment of the invention, a stackable article of furniture comprises at least one post having a longitudinal axis, a first end and a second end. A channel is formed in the at least one post parallel to the longitudinal axis and a pin is pivotally mounted to the at least one post within the channel and pivotable between a first position where the pin is completely within the channel and a second position where a portion of the pin protrudes from the first end.

According to another embodiment of the invention, an assembly of stackable furniture comprises first and second articles of furniture, each having at least one post having a longitudinal axis, a first end and a second end. A channel is formed in the at least one post parallel to the longitudinal axis and a pin is pivotally mounted to the at least one post within the channel and pivotable between a first position where the pin is completely within the channel and a second position where a portion of the pin protrudes from the first end. A slot in of the first and second articles of furniture is dimensioned to receive the pin. When the pin on the first article of furniture is in the second position, the second end of the second article of furniture receives the pin of the first article of furniture to retain the second article of furniture stacked on the first article of furniture.

### BRIEF DESCRIPTION OF THE DRAWINGS

In the drawings:

FIG. 1A is a side elevation view of stackable articles of furniture according to an embodiment of the invention.

FIG. 1B is a front elevation view of the stackable articles of furniture of FIG. 1.

FIG. 2A is a perspective view of a pin in a first position according to an embodiment of the invention.

FIG. 2B is a perspective view of a pin in an intermediate position according to an embodiment of the invention.

FIG. 2C is a perspective view of a pin in a second position according to an embodiment of the invention.

FIG. 3 is a perspective view of a slot according to an embodiment of the invention.

FIG. 4 is a sectional view of the pin received in the slot according to an embodiment of the invention.

### DETAILED DESCRIPTION

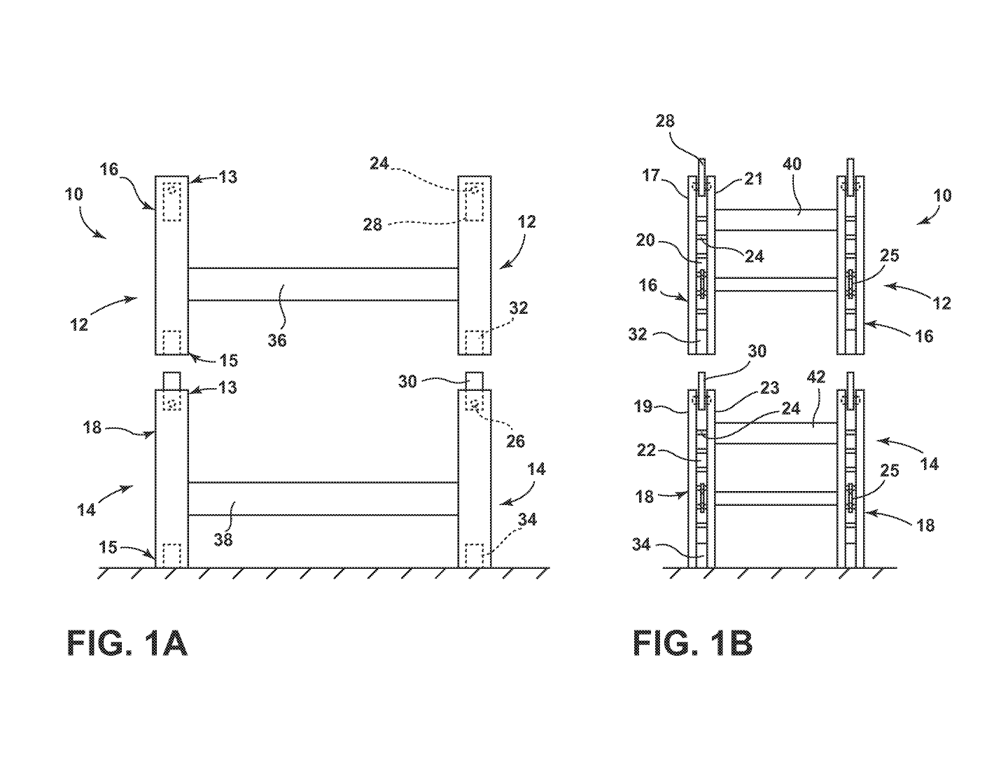

Turning to the drawings and to FIGS. 1A and 1B in particular, there is shown side and front elevation views of stackable articles of furniture 10 according to an embodiment of the invention. The stackable articles of furniture 10 depict a bunk bed having a first frame member 12 and a second frame member 14. While the stackable articles of furniture 10 are illustrated as a bunk bed, it will be understood that this is by way of example and that any stackable article of furniture is within the scope of the invention.

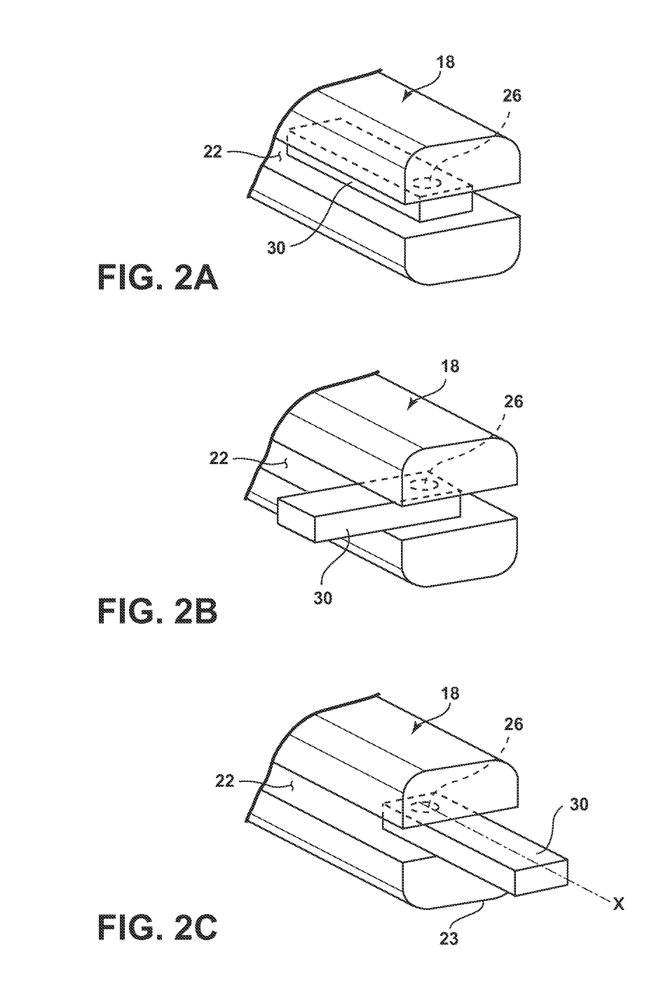

Each frame member 12, 14 includes at least one post 16, 18 having first 13 and second 15 ends. Each post 16, 18 has a first member 17, 19 spaced from a second member 21, 23 wherein the first and second members 17, 19 are connected together by links 24. The space between the first and second members 17, 21 defines a channel 20 in the post 16, and the space between the first and second members 19, 23 defines a channel 22 in the post 18. Each channel 20, 22 has a longitudinal axis X in the respective posts 16, 18 (See FIG. 2C). Each channel 20, 22 may extend between the first and second ends 13, 15 of the posts 16, 18 or only a portion thereof. Links 24 are preferably spaced from each other to also accommodate side rails 36, 38 that are connectable to the frame members 12, 14 in conventional manner so as to construct a bed frame. FIG. 1B shows where hangers 25 on side rails 36, 38 may be connected to the links 24 of the frame members 12, 14.

A pin 28, 30 in each respective post 16, 18 is pivotally mounted within the channel 20, 22 and is pivotable about a hinge link 26 between a first position where the pin 16, 18 is completely within the channel 20, 22, as shown with the first frame member 12 in FIG. 1A, and a second position where a portion of the pin 28, 30 protrudes from the first end 13, as shown with the second frame member 14 in FIG. 1A. The second end 15 of each post 16, 18 includes a slot 32, 34 dimensioned to receive the pin 28, 30. When the first frame member 12 is stacked on the second frame member 14, the pin 30 of the second frame member 14 is in the second position and is received in the slot 32 of the first frame member, thereby securing the posts 16, 18 together.

Each frame member 12, 14 will typically have more than one post 16, 18. For example, in FIG. 1B, each frame member 12, 14 includes two posts 16, 18 connected to each other a cross member 40, 42. To construct the bunk beds, two frame members 12, 14 are connected together by side rails 36, 38 in conventional manner.

FIG. 2A shows one of the pins 30 in the first position where it is completely within the channel 22 and pivotally mounted to the post 18 via the hinge link 26. It will be understood that the pin 30 may be mounted to the post 18 in another fashion such as by a rivet or a bearing. The channel 22 may have a width sufficient to allow a user to press a side of the pin 30 in order to pivot it to an intermediate position as shown in FIG. 2B. The pin 30 may then be pivoted to the second position as illustrated in FIG. 2C where a longitudinal axis of the pin 30 coincides with the longitudinal axis X of the post 18. The post 18 may also be equipped with a stopping mechanism such as a protrusion extending into the channel 22 to prevent continued pivoting of the pin 30 when in it reaches the second position. The pin may also be biased to one of the first or second positions by means of a spring or the weight of the pin 32 itself.

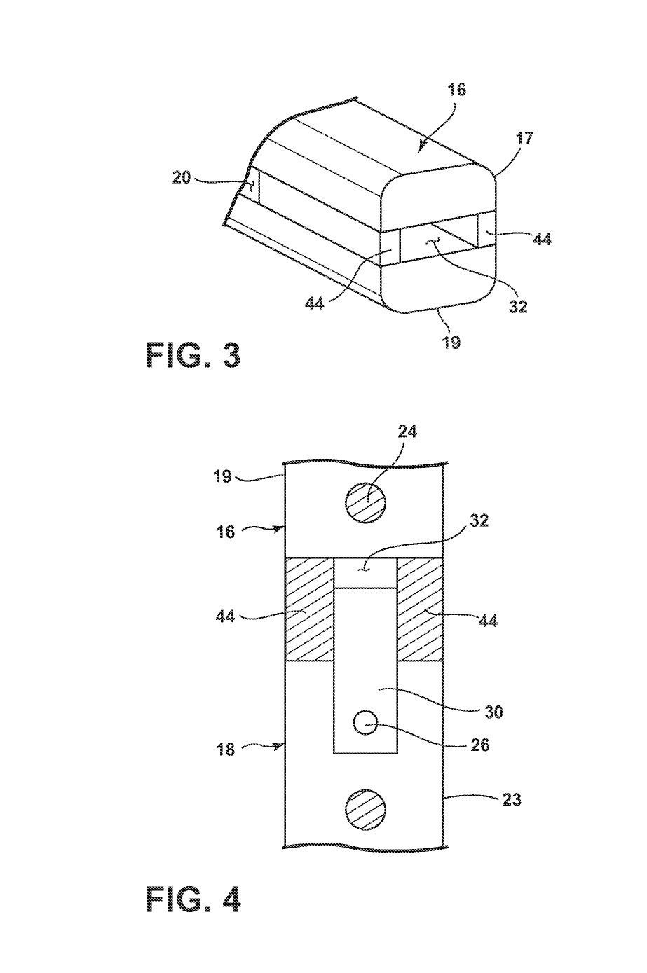

FIG. 3 shows a slot 32 formed in the second end 15 of the post 16. The post 16 can have side walls 44 extending between the first and section members 17, 19 of the post 16 to partially define the slot 32. Preferably the slot 32 will be dimensioned nominally larger than the pin 30 so to enable the pin 30 to be slidably received within the slot 32, without significant resistance and with little lateral movement. As seen in FIG. 4, the pin 30 is received in the slot 32 such that the first and section portions 17, 19 and the side walls 44 prevent lateral movement or post 18 or pivoting of the pin 30. It can also be seen that the pin may have a quadrilateral cross section to prevent rotation of the posts 16, 18 relative to each other.

The embodiments of the invention provide for a plurality of benefits including that the pivoting pin allows stackable articles of furniture to be secured together and allows the pin the be hidden from sight when the stackable articles of furniture are not stacked together. Furthermore, it allows two stackable articles of furniture to be retained together within the need for tools or for removing a fastener.

It will be understood that other channel configurations are possible. For example, each post 16, 18 may be a unitary piece, each having the respective channel 20, 22 formed therein as by routing or machining such that the pin 30 is movable through only one side of the post.

While the invention has been specifically described in connection with certain specific embodiments thereof, it is to be understood that this is by way of illustration and not of limitation. Reasonable variation and modification are possible with the scope of the foregoing disclosure and drawings without departing from the spirit of the invention which, is defined in the appended claims. Hence, specific dimensions and other physical characteristics relating to the embodiments disclosed herein are not to be considered as limiting, unless the claims expressly state otherwise.

What is claimed is:

1. A stackable article of furniture comprising:
at least one post having a longitudinal axis, a first end and a second end;
a channel in the at least one post parallel to the longitudinal axis; and
a pin pivotally mounted to the at least one post within the channel and pivotable between a first position where the pin is completely within the channel and a second position where a portion of the pin protrudes from the first end.

2. The stackable article of furniture of claim 1 wherein the second end has a slot dimensioned to receive a second pin of a second stackable article of furniture.

3. The stackable article of furniture of claim 1 wherein the pin has a quadrilateral cross section.

4. The stackable article of furniture of claim 1 wherein the channel extend between the first end and second end of the post.

5. The stackable article of furniture of claim 1 wherein the pin is biased to one of the first or second positions.

6. The stackable article of furniture of claim 1 wherein the stackable article of furniture is one of a bed frame, a bunk bed frame, a loft frame or a shelving frame.

7. The stackable article of furniture of claim 1 wherein the at least one post comprises a first portion spaced from a second portion wherein the first and second portions are connected together, define the channel therebetween.

8. The stackable article of furniture of claim 7 wherein the first and second portions are connected together by at least one link and the pin is pivotally mounted to the at least one link.

9. An assembly of stackable furniture comprising:
first and second articles of furniture, each having at least one post having a longitudinal axis, a first end and a second end;
a channel in the at least one post parallel to the longitudinal axis; and
a pin pivotally mounted to the at least one post within the channel and pivotable between a first position where the pin is completely within the channel and a second position where a portion of the pin protrudes from the first end;
a slot dimensioned to receive the pin;
wherein when the pin on the first article of furniture is in the second position, the second end of the second article of furniture receives the pin of the first article of furniture to retain the second article of furniture stacked on the first article of furniture.
